(19) United States
(12) Patent Application Publication
(10) Pub. No.: US 2012/0306297 A1
(43) Pub. Date: Dec. 6, 2012

(54) SWITCHED RELUCTANCE MOTOR

(75) Inventors: Changsung Sean Kim, Gyunggi-do (KR); Chang Hwan Choi, Gyunggi-do (KR); Han Kyung Bae, Gyunggi-do (KR); Guen Hong Lee, Seoul (KR)

(73) Assignee: SAMSUNG ELECTRO-MECHANICS CO., LTD., Gyunggi-do (KR)

(21) Appl. No.: 13/292,173

(22) Filed: Nov. 9, 2011

(30) Foreign Application Priority Data
Jun. 2, 2011 (KR) 1020110053434

(51) Int. Cl. H02K 37/04; H02K 1/18

(52) U.S. Cl. 310/46

(57) ABSTRACT

Disclosed herein is a switched reluctance motor, including: a rotor provided with a plurality of salient poles protruded along an outer peripheral surface thereof; and a stator including a plurality of stator cores in a pi (π) shape that have the rotor rotatably accommodated therein, are opposite to the plurality of salient poles, and have coils wound therearound, wherein a magnetic flux path is formed along the stator cores in the pi shape and the salient pole opposite thereto.

### CROSS REFERENCE TO RELATED APPLICATION

This application claims the benefit of Korean Patent Application No. 10-2011-0053434, filed on Jun. 2, 2011, entitled “Switched Reluctance Motor” which is hereby incorporated by reference in its entirety into this application.

### BACKGROUND OF THE INVENTION

1. Technical Field

The present invention relates to a switched reluctance motor.

2. Description of the Prior Art

Recently, a demand for a motor has largely increased in various industries such as vehicles, aerospace, military, medical equipment, or the like. In particular, a cost of a motor using a permanent magnet is increased due to the sudden price increase of a rare earth material, such that a switched reluctance motor (hereinafter, referred to as an SR motor) has become interested as a new alternative.

A driving principle of an SR motor rotates a rotor using a reluctance torque generated according to the change in magnetic reluctance.

Generally, the switched reluctance motor is configured to include a stator 10 including a plurality of fixing salient poles 11 and a rotor 20 including a plurality of rotating salient poles 22 opposite to the plurality of fixing salient poles 11 as shown in FIG. 1.

In more detail, the stator 10 is configured to include the plurality of fixing salient poles 11 protruded toward the rotor 20 at a predetermined distance along a circumferential direction of an inner peripheral surface of the stator 10 and coils 12 wound around each of the fixing salient poles 11.

The rotor 20 is stacked with cores 21 in which the plurality of rotating salient poles 22 opposite to each of the fixing salient poles 11 are protruded at a predetermined distance in a circumferential direction.

Further, the center of the rotor 20 is coupled with a rotating shaft 30 that transfers a driving force of the motor to the outside so as to integrally rotate with the rotor 20.

Further, a concentrated type coil 12 is wound around the fixing salient poles 11, while the rotor 20 is configured of only a core without any type of excitation device, for example, a winding of a coil or a permanent magnet.

Therefore, when current flows in the coil 12 from the outside, the rotor 20 generates the reluctance torque moving in the coil 12 direction by magnetic force generated from the coil 12, such that the rotor 20 rotates in a direction in which the reluctance of a magnetic circuit is minimized.

On the other hand, the SR motor according to the prior art may lead to core loss since a magnetic flux path passes through both of the stator 10 and the rotor 20.

### SUMMARY OF THE INVENTION

The present invention has been made in an effort to provide a switched reluctance motor capable of reducing manufacturing costs while reducing a weight of a stator.

In addition, the present invention has been made in an effort to provide a switched reluctance motor including a stator core in a pi (π) shape so as to make a magnetic flux path short.

According to a preferred embodiment of the present invention, there is provided a switched reluctance motor, including: a rotor provided with a plurality of salient poles protruded along an outer peripheral surface thereof; and a stator including a plurality of stator cores in a pi (π) shape that have the rotor rotatably accommodated therein, are opposite to the plurality of salient poles, and have coils wound therearound, wherein a magnetic flux path is formed along the stator cores in the pi shape and the salient pole opposite thereto.

The one stator core may include: a yoke; and two stator salient poles protruded from the yoke so as to be opposite to the salient pole, wherein a cross section of the stator core orthogonal to a rotating shaft is in the pi (π) shape.

The stator may further include a support filled between the plurality of stator cores so as to fix each of the stator cores.

The support may be made of a resin material that is a non-magnetic material and an insulating material.

The support filled between the stator cores may have a cooling unit fixed to the inside thereof in order to discharge heat generated from the motor.

The resin material that is a non-magnetic material and an insulating material may be coupled between the salient poles.

The rotor may include: a rotor core provided with a hollow hole to which a rotating shaft is fixed; and the salient poles protruded from the outer peripheral surface of the rotor core to be opposite to the stator core.

The rotor core may be provided with a plurality of holes disposed between the hollow hole and the salient pole along a circumferential direction.

The stator may form a three phase, including six stator cores in a pi shape, so that a ratio of the stator salient pole to the rotor salient pole is 12:10.

Both ends of the yoke may extend to face ends of the adjacent yokes and the ends of the yoke facing each other to be extendedly formed may be each press-fitted.

One end of the yoke may be provided with a protruding part protruded to the outside and the other end thereof may be provided with a coupling groove so as to be press-fitted in the protruding part formed on one end of the yoke adjacent thereto.

The plurality of blocking holes disposed at the yoke while being spaced from each other at a predetermined distance may be formed so as to block the magnetic flux from flowing in the stator core connected to both sides of the yoke.

The stator salient pole may have a tapered shape that is inclined at an end opposite to the salient pole from the yoke.

Both ends of the yoke may extend toward the end of the yoke adjacent thereto so as to be coupled with each other, such that the plurality of stator cores in the pi shape are integrally connected to each other.

The plurality of blocking holes disposed at the yoke while being spaced from each other at a predetermined distance may be formed in order to block the magnetic flux flowing in the yoke via the rotor salient pole from flowing in the yoke connected to both sides thereof.

### BRIEF DESCRIPTION OF THE DRAWINGS

FIG. 1 is a cross-sectional view of a switched reluctance motor according to the prior art.

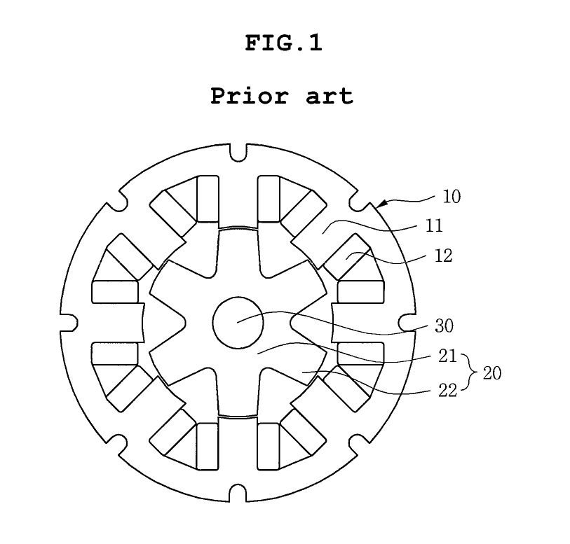

FIGS. 2A and 2B are cross-sectional views schematically showing a driving of the switched reluctance motor according to the preferred embodiment of the present invention.

FIG. 3 is a perspective view of the switched reluctance motor shown in FIG. 2.

FIG. 4 is a cross-sectional view of a switched reluctance motor according to another preferred embodiment of the present invention.

FIG. 5 is a perspective view of the switched reluctance motor shown in FIG. 4.

FIG. 6 is a cross-sectional view of a switched reluctance motor according to another preferred embodiment of the present invention.

FIG. 7 is a perspective view of the switched reluctance motor shown in FIG. 6.

FIG. 8 is a cross-sectional view of a modified rotor according to the preferred embodiment of the present invention.

FIG. 9 is a cross-sectional view of the switched reluctance motor to which a modified rotor shown in FIG. 8 is applied.

FIG. 10 is a cross-sectional view of a switched reluctance motor to which a modified stator is applied according to the preferred embodiment of the present invention.

### DESCRIPTION OF THE PREFERRED EMBODIMENTS

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In addition, the terms “first”, “second”, “one surface”, “the other surface” and so on are used to distinguish one element from another element, and the elements are not defined by the above terms. In describing the present invention, a detailed description of related known functions or configurations will be omitted so as not to obscure the gist of the present invention.

Hereinafter, preferred embodiments of the present invention will be described in detail with reference to the accompanying drawings.

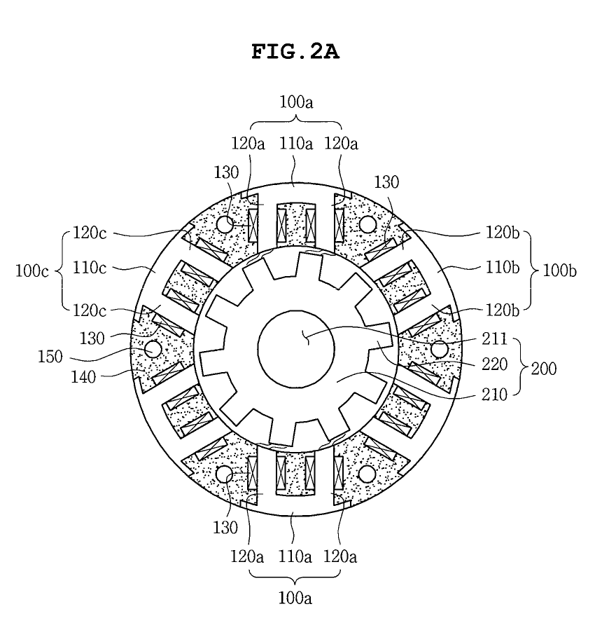

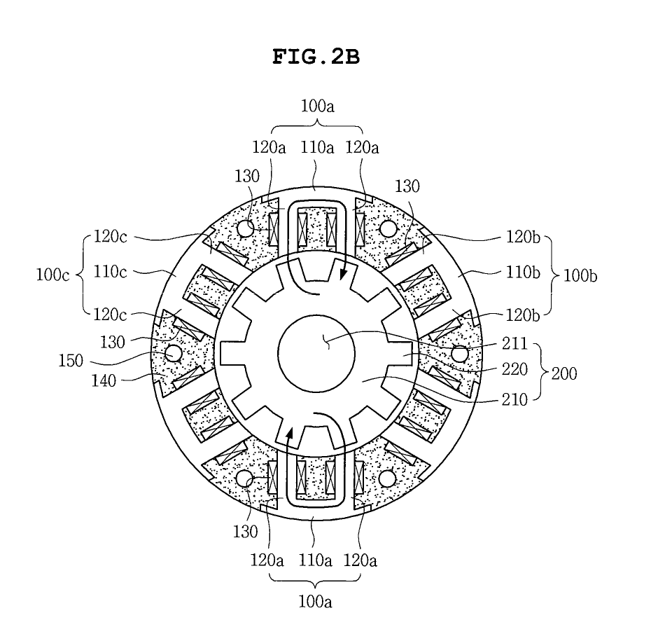

FIGS. 2A and 2B are cross-sectional views schematically showing a driving of the switched reluctance motor according to the preferred embodiment of the present invention and FIG. 3 is a perspective view of the switched reluctance motor shown in FIG. 2. As shown, the switched reluctance motor according to the preferred embodiment of the present invention includes a stator 100 and a rotor 200 rotating in one direction by reluctance torque generated by a magnetic force with the stator 100.

In more detail, the rotor 200 includes a rotor core 210 and a plurality of salient poles 220.

As shown, a center of the rotor core 210 is provided with a hollow hole 211 to which a rotating shaft 230 for transferring a rotating force of the motor to the outside is fixed.

In addition, the preferred embodiment of the present invention implements a 3-phase switched reluctance motor. As shown, a total of 10 salient poles 220 protruded from an outer peripheral surface of the rotor core 210 are formed.

Further, in the preferred embodiment of the present invention, a total of 10 rotor salient poles may be formed, but a total of five rotor salient poles protruded from the rotor core may be formed.

In addition, the rotor core 210 and the salient poles 220 are made of a metal material so as to generate the reluctance torque.

As shown, the stator 100 includes a plurality of stator cores 100a, 100b, and 100c, a support 140, and a cooling unit 150.

In more detail, the plurality of stator cores 100a, 100b, and 100c are arranged to have a cylindrical shape to rotatably accommodate the rotor 200 therein.

Further, the one stator core 100a is configured to include a yoke 110a and a plurality of salient poles 120a of a stator.

In addition, as shown, in order to configure a single phase, one stator core 100a and the other one stator core 100a may be disposed on the same line so as to be opposite to each other.

In more detail, the stator salient poles 120a are protruded from an inner peripheral surface of the yoke 110a so as to be opposite to the salient poles 220 and one yoke 110a is provided with two stator salient poles 120a.

Therefore, one stator salient pole 120a has a cross section orthogonal in a pi (π) shape or a π shape orthogonal to a rotating shaft.

According to the preferred embodiment of the present invention, the plurality of stator cores 100a, 100b, and 100c are similarly formed to have a pi (π) shape or a π shape.

In addition, a coil 130 applied with power from the outside is wound around the stator salient pole 120a several times.

In addition, the yoke 110a and the stator salient poles 120a are made of a metal material so as to generate the reluctance torque.

Further, as described above, the preferred embodiment of the present invention implements a 3-phase switched reluctance motor.

Therefore, the number of stator cores opposite to the rotor 200 is three pairs of stator cores 100a, 100b, and 100c so that the stator cores facing each other forms one phase. As a result, the stator 100 is configured to have a total of six stator cores in a pi (π) shape.

Therefore, the number of stator salient poles 120 is 12 in total.

In addition, according to the preferred embodiment of the present invention, the 3-phase switched reluctance motor may include six stator cores in a pi shape so that a ratio of the stator salient pole 120 to the rotor 200 salient pole 220 is 12:10, but may include three stator cores in a pi shape so that a ratio of the stator salient pole to the rotor salient pole is 6:5.

Further, the support 140 is filled between the stator salient pole 120a configuring one stator core 100a and the stator salient pole 120a configuring the one stator core 100a and the stators 100a, 100b, and 100c adjacent to each other.

In more detail, according to the preferred embodiment of the present invention, the stator cores 100a, 100b, and 100c are each separated in a segment form, such that the support 140 is filled in a space between the stator core 100a and the stator core 100b and the stator core 100a and the stator core 100c so as to couple the stator cores with each other.

In addition, according to the preferred embodiment of the present invention, so as to block the magnetic flux from moving among the stator cores 100a, 100b, and 100c, the support 140 may be made of a resin material that is a non-magnetic material and an insulating material.

As a result, as compared with the switched reluctance motor according to the prior art in which the entire stator is manufactured into metal, only the stator core in a pi shape according to the preferred embodiment of the present invention in which the magnetic flux flows is made of a metal material and the other portion thereof is made of a resin material, such that the weight of the stator and the manufacturing costs of the stator may be reduced.

Further, the switched reluctance motor generates heat due to the driving over a long period of time. As shown in FIGS. 2A, 2B, and 3, in order to discharge heat generated from the inside of the motor, the cooling unit 150 is coupled with the inside of the support 140 filled between the stator cores 100a, 100b, and 100c adjacent to each other.

In more detail, the cooling unit 150 may be coupled with the center of the support 140 so as not to contact the coil 130 wound around the stator cores 100a, 100b, and 100c adjacent to each other.

In addition, the cooling unit 150 according to the preferred embodiment of the present invention is configured of a water cooling pipe, but the preferred embodiment of the present invention may use a cooling unit using other refrigerants without being limited thereto.

Therefore, as shown in FIG. 2A, when power is applied to the coil 130, the reluctance torque is generated according to the change in magnetic reluctance and then, the rotor 200 rotates toward the stator salient pole 120a of the stator core 100a which has the most approximate pi shape.

In this case, the flowing of magnetic flux flowing the stator core 100a and the rotor 200 passes through the yoke 110a having a pi (π) shape, two stator salient poles 120a, and the rotor 200.

In more detail, the flowing of magnetic flux is as follows.

First, the magnetic flux flows in the one salient pole 220 opposite to the one stator salient pole 120a, flows along the other remaining one salient pole 220 via the rotor core 210, and then, flows in the yoke 110a via the other remaining one stator salient pole 120a, such that the magnetic flux path is shorter than that of the switched reluctance motor of the prior art.

Therefore, the core loss may be reduced by making the magnetic flux path short by the stator cores 100a, 100b, and 100c in a pi shape and the rotor 200 opposite thereto, as compared with the switched reluctance motor of the prior art.

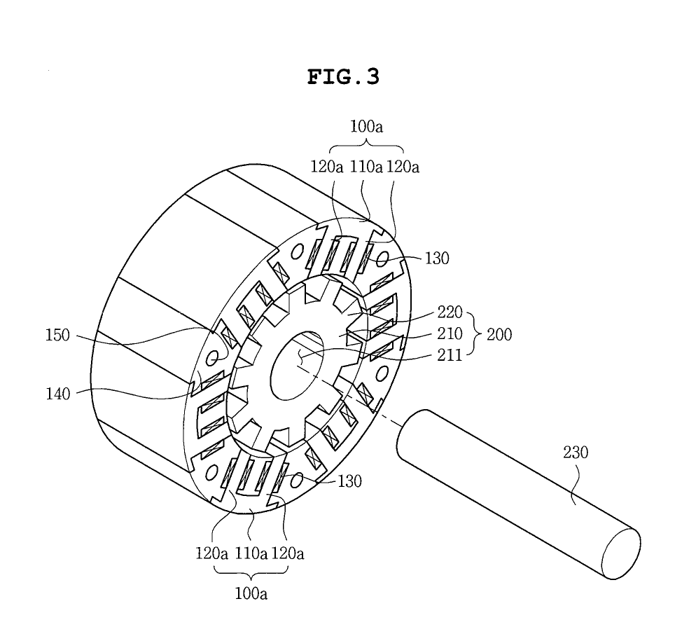

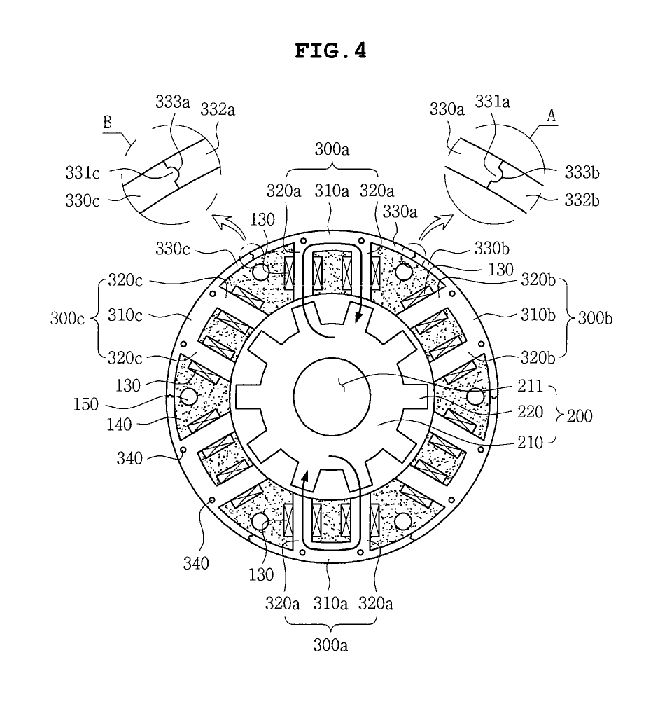

FIG. 4 is a cross-sectional view of a switched reluctance motor according to another preferred embodiment of the present invention and FIG. 5 is a perspective view of the switched reluctance motor shown in FIG. 4. In describing the preferred embodiment of the present invention, the same or corresponding components to the foregoing preferred embodiments are denoted by the same reference numerals and therefore, the description of the overlapping portions will be omitted. Hereinafter, the switched reluctance motor according to the preferred embodiment of the present invention will be described with reference to FIGS. 4 and 5.

As shown, the switched reluctance motor includes a stator 300 including a plurality of stator cores 300a, 300b, and 300c and a rotor 200 rotating in one direction by the stator 300 and the reluctance torque.

In more detail, the one stator core 300a is configured to include a yoke 310a and two stator salient poles 320a protruded from an inner peripheral surface of the yoke 310a.

Therefore, the plurality of stator cores 300a, 300b, and 300c according to the preferred embodiment of the present invention are similarly formed to have a pi (π) shape or a π shape.

Further, both ends 330a and 332a of the one stator yoke 310a are coupled with each other so as to extend toward ends 332b and 330c of the stator yoke adjacent to each other.

In more detail, one end 330a of the one stator yoke 310a is provided with a protruding part 331a protruded to the outside.

Further, the opposite other end 332a is provided with a coupling groove 333a corresponding to the shape of the protruding part 331a.

Therefore, as shown in FIGS. 4A and 4B that are enlarged views, the stator core 300a are coupled with the stator cores 300b and 300c disposed at both sides thereof by using the protruding part 331a and the coupling groove 333a formed on the both ends 330a and 332a of the yoke 310a.

In more detail, the protruding part 331a formed on one end 330a of the yoke 310a is press-fitted in the coupling groove 333b formed on the other end 332b of the yoke 310b adjacent thereto.

In addition, the coupling groove 333a formed on the other end 332a of the yoke 310a is press-fitted in the protruding part 331c formed on one end 330c of the yoke 310c.

Therefore, in a process of manufacturing the motor, a yield of the assembly may be improved since the coupling of the stator core is easily performed.

Further, it is possible to exchange or repair the stator core due to breakage during the operation of the motor.

In addition, in order to block the magnetic flux from moving in a direction of the stator cores 300b and 300c coupled with both sides of the one yoke 310a, a plurality of blocking holes 3 are formed.

Therefore, as shown, since the magnetic flux path is formed of only the stator core 300a and the two salient poles 220 opposite to the stator core 300a, the magnetic flux path may be shortened, as compared with the switched reluctance motor of the prior art.

Further, the magnetic flux path entering the yoke 310a via the stator salient pole 320a from the salient pole 220 flows in the blocking hole 340, thereby making the magnetic flux path shorter.

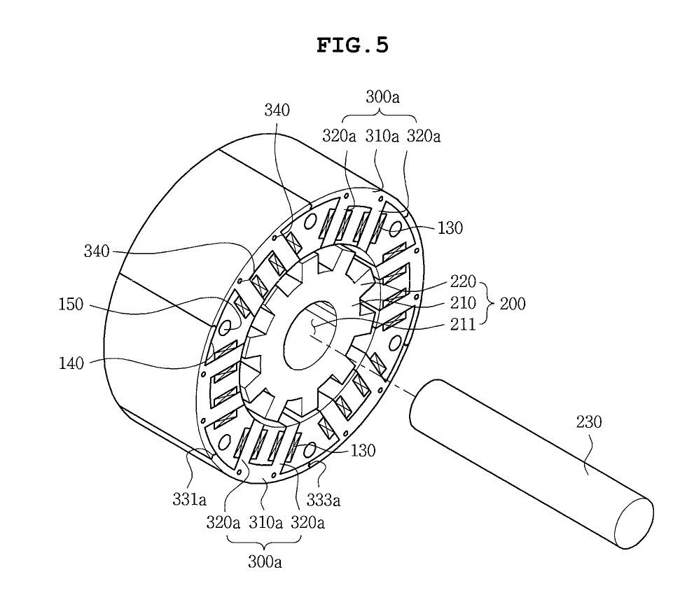

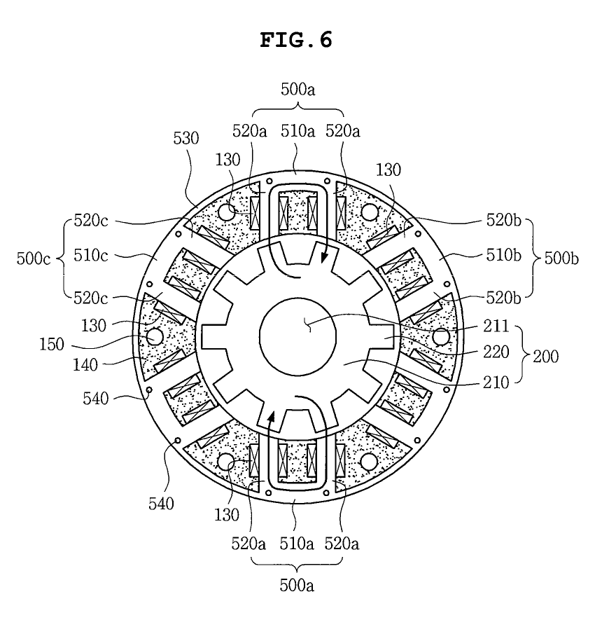

FIG. 6 is a cross-sectional view of a switched reluctance motor according to another preferred embodiment of the present invention and FIG. 7 is a perspective view of the switched reluctance motor shown in FIG. 6. In describing the preferred embodiment of the present invention, the same or corresponding components to the foregoing preferred embodiments are denoted by the same reference numerals and therefore, the description of the overlapping portions will be omitted. Hereinafter, the switched reluctance motor according to the preferred embodiment of the present invention will be described with reference to FIGS. 6 and 7.

As shown, the switched reluctance motor includes a stator 500 and a rotor 200 rotating in one direction by the stator 500 and the reluctance torque.

In more detail, the stator 500 is configured to include a yoke 510 and a plurality of stator salient poles 520 protruded to be opposite to the salient pole 220 from the yoke 510.

Therefore, the stator 500 has a pi (π) shape or a π shape.

As shown, yokes 510a, 510b, and 510c adjacent to each other are integrally connected to each other to form a cylindrical outside 530, thereby configuring the stator 500.

As a result, according to a third preferred embodiment of the present invention, the plurality of stator cores 500a, 500b, and 500c in a pi (π) shape are integrally manufactured.

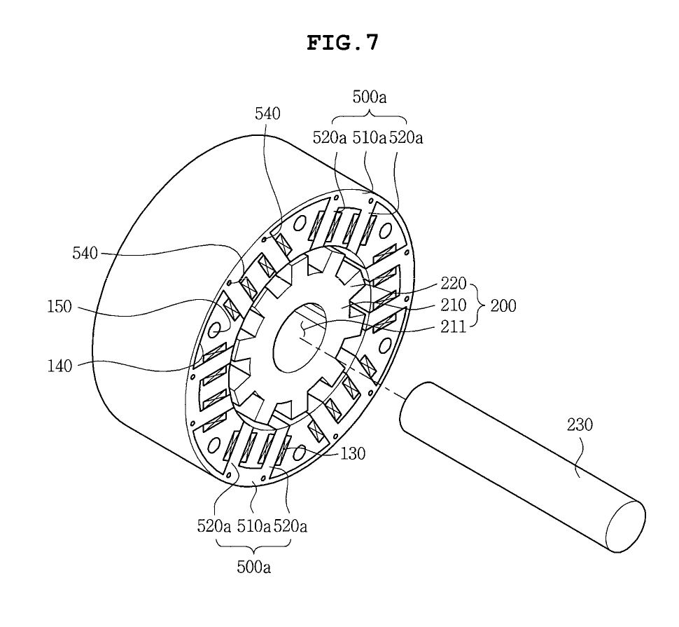

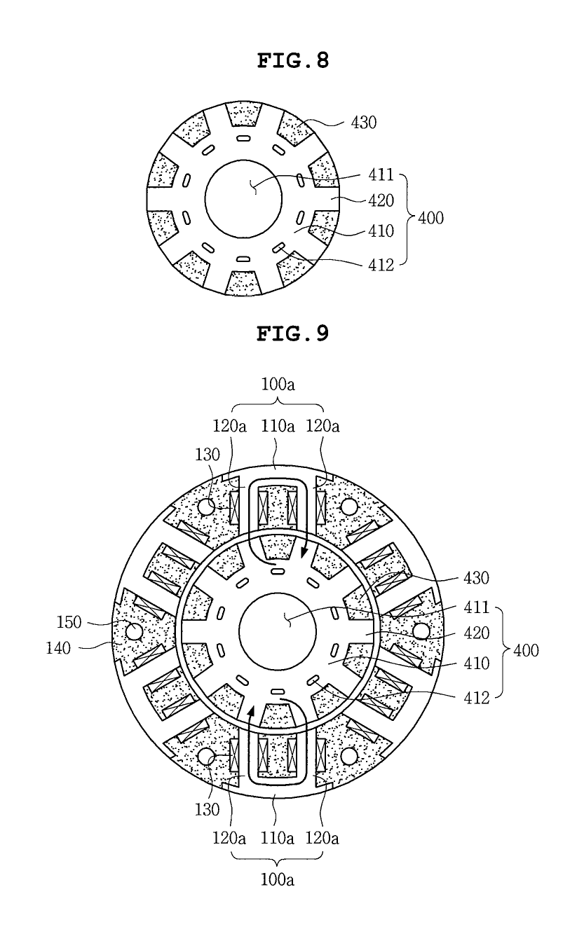

FIG. 8 is a cross-sectional view of a modified rotor according to the preferred embodiment of the present invention and FIG. 9 is a cross-sectional view of the switched reluctance motor to which a modified rotor shown in FIG. 8 is applied.

As shown, the resin material 420 is coupled between the outer peripheral surface of the rotor core 410 and each salient pole 420.

In more detail, the resin material 430 is made of a non-magnetic material and an insulating material to block the flowing of magnetic flux moving along the one salient pole 420 from moving to the other one salient pole 420 adjacent thereto and may structurally support each salient pole 420.

In addition, it is possible to prevent rotation noise that may be generated by an empty space between the salient poles 420 and it is possible to improve the rotating force by reducing the friction with air.

Further, the plurality of blocking holes 412 are formed between the hollow hole 411 to which the rotating shaft (not shown) is fixed and the salient pole 420 along the circumferential direction of the rotor 410.

In more detail, as shown in FIG. 9, the magnetic flux entering the rotor core 410 via the salient pole 420 flows in the blocking hole 412 by the plurality of blocking holes 412, thereby making the magnetic flux path shorter.

Further, the rotor 400 may be applied to the stator cores 100a, 100b, and 100c in the pi shape shown in FIG. 9, the stator with which the stator cores adjacent to each other shown in FIG. 4 is coupled, and the integrated stator shown in FIG. 6.

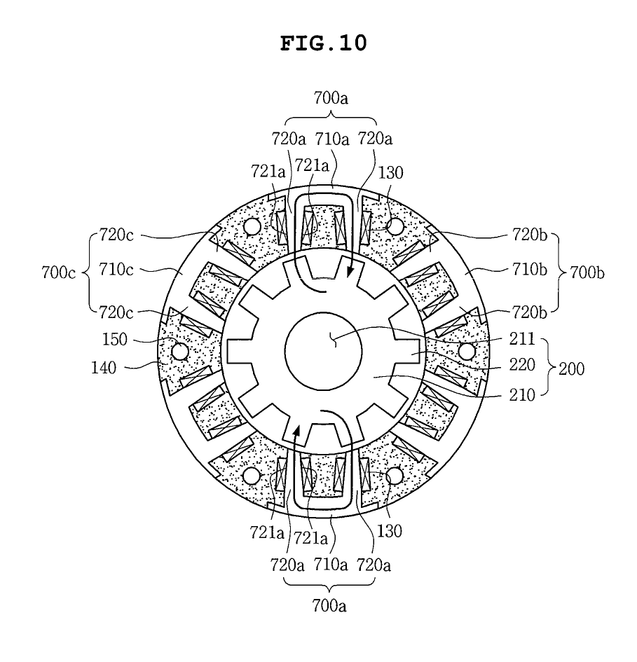

FIG. 10 is a cross-sectional view of a switched reluctance motor to which a modified stator is applied according to the preferred embodiment of the present invention. As shown, the switched reluctance motor includes a stator 700 including a plurality of stator cores 700a, 700b, and 700c and the rotor 200 rotating in one direction by the stator 700 and the reluctance torque.

In more detail, the one stator core 700a is configured to include a yoke 710a and two stator salient poles 720a protruded from an inner peripheral surface of the yoke 710a.

Therefore, according to the preferred embodiment of the present invention, the plurality of stator cores 700a, 700b, and 700c are similarly formed to have a pi (π) shape or a π shape.

In more detail, the stator salient pole 720a has a taper shape to be gradually inclined toward the end 721a opposite to the salient pole 220 from the yoke 710a.

Therefore, it is possible to smooth the movement of magnetic flux to the stator cores 700a, 700b, and 700c in the pi (π) shape and the salient pole 220 of the rotor 200 opposite thereto by preventing the magnetic flux from being saturated in the end 721a of the stator salient pole 720a.

As set forth above, the preferred embodiment of the present invention can provide the stator core in the pi (π) shape, thereby making the magnetic flux path short.

In addition, the preferred embodiment of the present invention can make the magnetic flux path short, thereby improving the characteristics and efficiency of the motor and reducing the core loss.

In addition, the preferred embodiment of the present invention can provide the stator core in the pi shape to manufacture the stator as a separated type, a coupling integrated type, or an integrated type in which the plurality of stator cores in the pi shape are coupled, thereby reducing the manufacturing cost of the motor and the weight of the stator.

Although the preferred embodiments of the present invention have been disclosed for illustrative purposes, they are for specifically explaining the present invention and thus a switched reluctance motor according to the present invention is not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A switched reluctance motor, comprising:
a rotor provided with a plurality of salient poles protruded along an outer peripheral surface thereof; and
a stator including a plurality of stator cores in a pi (π) shape that have the rotor rotatably accommodated therein, are opposite to the plurality of salient poles, and have coils wound therearound,
wherein a magnetic flux path is formed along the stator cores in the pi shape and the salient pole opposite thereto.

2. The switched reluctance motor as set forth in claim 1, wherein the one stator core includes:
a yoke; and
two stator salient poles protruded from the yoke so as to be opposite to the salient pole,
wherein a cross section of the stator core orthogonal to a rotating shaft is the pi (π) shape.

3. The switched reluctance motor as set forth in claim 1, wherein the stator further includes a support filled between the plurality of stator cores so as to fix each of the stator cores.

4. The switched reluctance motor as set forth in claim 3, wherein the support is made of a resin material that is a non-magnetic material and an insulating material.

5. The switched reluctance motor as set forth in claim 3, wherein the support filled between the stator cores has a cooling unit fixed to the inside thereof in order to discharge heat generated from the motor.

6. The switched reluctance motor as set forth in claim 1, wherein the resin material that is a non-magnetic material and an insulating material is coupled between the salient poles.

7. The switched reluctance motor as set forth in claim 1, wherein the rotor includes:
a rotor core provided with a hollow hole to which a rotating shaft is fixed; and
the salient poles protruded from the outer peripheral surface of the rotor core to be opposite to the stator core.

8. The switched reluctance motor as set forth in claim 7, wherein the rotor core is provided with a plurality of holes disposed between the hollow hole and the salient pole along a circumferential direction.

9. The switched reluctance motor as set forth in claim 2, wherein the stator forms a three phase, including six stator cores in a pi shape, so that a ratio of the stator salient pole to the rotor salient pole is 12:10.

10. The switched reluctance motor as set forth in claim 1, wherein both ends of the yoke extend to face ends of the adjacent yokes and the ends of the yoke facing each other to be extendedly formed are each press-fitted.

11. The switched reluctance motor as set forth in claim 10, wherein one end of the yoke is provided with a protruding part protruded to the outside and the other end thereof is provided with a coupling groove so as to be press-fitted in the protruding part formed on one end of the yoke adjacent thereto.

12. The switched reluctance motor as set forth in claim 10, wherein the plurality of blocking holes disposed at the yoke while being spaced from each other at a predetermined distance are formed so as to block the magnetic flux from flowing in the stator core connected to both sides of the yoke.

13. The switched reluctance motor as set forth in claim 2, wherein the stator salient pole has a tapered shape that is inclined at an end opposite to the salient pole from the yoke.

14. The switched reluctance motor as set forth in claim 1, wherein both ends of the yoke extend toward the end of the yoke adjacent thereto so as to be coupled with each other, such that the plurality of stator cores in the pi shape are integrally connected to each other.

15. The switched reluctance motor as set forth in claim 14, wherein the plurality of blocking holes disposed at the yoke while being spaced from each other at a predetermined distance are formed in order to block the magnetic flux flowing in the yoke via the rotor salient pole from flowing in the yoke connected to both sides thereof.
